(19) United States
(12) Patent Application Publication
(10) Pub. No.: US 2026/0218849 A1
(43) Pub. Date: Jul. 30, 2026

(54) Multi-Size Post Cap with Integrated Lighting Holder

(71) Applicants: John Pierson, Kennebunk, ME (US); Lisa Pierson, Kennebunk, ME (US)

(72) Inventors: John Pierson, Kennebunk, ME (US); Lisa Pierson, Kennebunk, ME (US)

(21) Appl. No.: 19/573,232

(22) Filed: Mar. 20, 2026

Related U.S. Application Data
(63) Continuation-in-part of application No. 18/907,819, filed on Oct. 7, 2024.

(51) Int. Cl. F16M 13/02; E04H 17/00; F21V 21/00; F21V 37/00

(52) U.S. Cl. CPC F16M 13/02; E04H 17/006; F21V 21/00; F21V 37/0075

(57) ABSTRACT

A post-mounted support assembly is disclosed comprising a cap body configured to engage a structural post and a receptacle configured to receive a removable lighting or decorative insert. The cap body includes a downwardly extending skirt defining an interior cavity and one or more internal engagement elements configured to secure the cap to posts of varying sizes and shapes without requiring fasteners. The receptacle is configured to receive a lighting element, including an oil torch canister or non-combustion lighting module, and may include stabilizing and heat management features. The assembly may be formed from durable outdoor-rated materials and may be used on fence posts, deck posts, or as a freestanding device. The invention provides a stable, modular, and adaptable system for integrating lighting or decorative elements into existing structures and outdoor environments.

### CROSS REFERENCE TO RELATED APPLICATION

This application claims priority to and is a continuation-in-part of U.S. patent application Ser. No. 18/907,819 filed Oct. 7, 2024, the contents of which are all incorporated herein by reference.

### FIELD OF THE INVENTION

The invention provides a post cap that is configured to simultaneously function as a structural cap for a fence or deck post and as a stable holder for a removable oil torches or similar lighting element or other decorative components

### BACKGROUND OF THE INVENTION

Outdoor living spaces such as patios, decks, and gardens have become increasingly popular in residential and commercial environments. Homeowners frequently incorporate fences, deck railings, and posts into these spaces both for safety and for aesthetic purposes. Fence posts and deck posts are commonly constructed from wood, PVC, composite materials, aluminum, or steel, and are typically finished with a decorative post cap.

In addition to structural features, outdoor spaces often incorporate decorative lighting elements to enhance ambiance and functionality. Oil torches are a well-known example of such lighting elements. Oil torches are commonly used to provide atmospheric lighting, decorative illumination, and in many cases to disperse citronella-based fuels that help deter mosquitoes and other insects. Despite their popularity, oil torches are often difficult to deploy in a secure and aesthetically pleasing manner.

Traditional oil torches are commonly mounted on thin metal poles that are inserted into the ground. These poles may be unstable in certain soil conditions, particularly in compacted or rocky terrain. Additionally, these ground-mounted torch poles may create clutter in landscaped environments and may present safety hazards when placed near walkways, decks, or patios.

Some torch holders have been developed for use on flat surfaces such as tables or stands. However, these holders typically lack stability in windy conditions or when placed in high-traffic areas. Furthermore, such holders often fail to integrate seamlessly with existing architectural features such as fences or deck structures.

At the same time, many residential outdoor environments already include numerous vertical posts as part of fence or deck systems. These posts are generally spaced at regular intervals and provide a natural framework for mounting decorative or functional accessories. Despite the widespread presence of these posts, there has historically been no simple and effective method for integrating oil torches directly into fence or deck post structures.

Existing fence caps primarily serve a limited function of covering the exposed top of a post in order to prevent water intrusion and to provide a finished aesthetic appearance. Conventional fence caps do not provide a secure receptacle for holding a torch canister or similar lighting element, nor do they provide a universal design capable of accommodating a range of post sizes and configurations.

Accordingly, there exists a need for an improved fence cap that integrates a torch holder into the cap itself. Such a device would ideally provide a secure and stable receptacle for an oil torch while maintaining compatibility with a variety of existing fence and deck post sizes and materials. Furthermore, such a device would preferably require minimal tools or fasteners for installation and would enhance the overall aesthetic appearance of outdoor living spaces.

### SUMMARY OF THE INVENTION

The invention discloses a fence cap designed to fit on the top of fence or deck posts. The innovative fence cap incorporates a designated holder for a torch, allowing for easy installation and stability. The unique design not only secures the torch but also fits on a variety of sized fence posts due to the unique internal design characteristics.

In embodiments of the subject invention, the device is a PVC form with a circular recess to accommodate an oil torch canister or other similarly shaped aesthetic component. In a preferred form, the cap fits in or around most fence or deck posts with no additional tools or fasteners.

In additional embodiments of the subject invention, the device may be a secure and standalone torch holder to be used on tables and other flat surfaces.

Further embodiments of the subject invention, provide for a metallic cap for metal fence posts in a variety of shapes and designs with the same basic premise of securely holding an oil torch canister.

The present invention addresses the foregoing needs by providing a fence cap designed to fit on the top of fence or deck posts while simultaneously incorporating a holder for an oil torch or similar lighting device.

In a preferred embodiment, the device comprises a cap body formed of molded plastic, PVC, metal, or other durable outdoor-rated materials. The cap body includes a top surface and a peripheral wall defining an interior cavity configured to engage the top of a fence or deck post. The cap further includes a recessed or protruding circular holder configured to receive and stabilize an oil torch canister.

The cap is designed with internal structural features that allow it to accommodate posts of varying sizes and configurations. These internal features may include channels, protrusions, ribs, or other geometries that allow the cap to either insert into the interior of a post, surround the exterior of a post, or engage with existing post adapters.

In certain embodiments, the device may be constructed as a two-piece modular system including a base cap and a removable oil canister assembly. The oil canister assembly may include a metal container for fuel, a wick, a wick holder, and a snuffer cap. A heat shield may also be provided to protect the underlying fence structure from heat generated by the flame.

In addition to mounting on fence or deck posts, the cap may also function as a standalone holder for a torch canister when placed on flat surfaces such as tables or patio surfaces. In further embodiments, the cap may be constructed from metallic materials to accommodate use with metal fence posts and to provide enhanced durability.

The invention therefore provides a convenient and aesthetically pleasing method for deploying oil torches in outdoor spaces while utilizing existing structural elements commonly found in residential and commercial environments.

In one embodiment, the present invention provides a post cap assembly comprising a cap body having a top surface and a downwardly extending skirt defining an interior cavity, wherein a plurality of internal engagement elements are disposed within the interior cavity. The internal engagement elements may be arranged in a non-uniform geometric pattern configured to frictionally engage posts of different cross-sectional sizes and shapes without the use of fasteners. The cap body further includes a receptacle configured to receive a removable torch canister or other decorative or functional insert.

In another embodiment, the cap body includes a deformable interior structure configured to elastically compress against an inner or outer surface of a structural post. The deformable interior structure may include flexible ribs, slotted wall sections, or elastomeric inserts, enabling the cap to securely attach to posts of varying dimensions while maintaining a tool-free installation.

In a further embodiment, the cap assembly includes multiple attachment modes, including a first engagement region configured to insert into a hollow post and a second engagement region configured to surround an exterior surface of a post. The cap assembly may be selectively mounted using either engagement region, thereby allowing compatibility with a wide range of post types, including wood, PVC, composite, and metal posts.

In another embodiment, the invention provides a freestanding lighting support device comprising a cap body having a substantially planar lower surface configured to rest on a horizontal support surface such as a table, deck, or patio. The cap body includes a recessed holder configured to receive a removable torch canister and may further include a weighted region or non-slip material to enhance stability and resist tipping during use.

In yet another embodiment, the cap assembly includes a thermal isolation structure positioned between the torch receptacle and the cap body. The thermal isolation structure may include an air gap, a metallic heat shield, or insulating materials configured to reduce heat transfer from a flame associated with the torch canister to the cap body and the underlying post.

In a modular embodiment, the invention comprises a base cap configured to attach to a structural post and a removable insert configured to be received within an opening in the base cap. The removable insert may include a holder for a lighting element and may be secured by a snap-fit, threaded connection, or frictional engagement, thereby allowing interchangeability of inserts and ease of replacement.

In another embodiment, the cap body includes an internal channel configured to engage a commercially available post adapter. The internal channel may be dimensioned to accommodate standard post adapter sizes, including but not limited to four-inch and five-inch adapters, thereby enabling compatibility with existing fence and deck systems.

In a further embodiment, the interior cavity of the cap body includes multiple discrete engagement surfaces oriented to contact posts of differing cross-sectional geometries, including square, rectangular, circular, and irregular shapes. These engagement surfaces may be symmetrically or asymmetrically arranged and may include resilient coatings or materials to enhance grip and reduce movement.

In another embodiment, the cap assembly includes a weather-resistant configuration comprising a downwardly extending skirt and an outwardly extending lip configured to overlap the exterior of a post. The cap body may further include one or more drainage channels configured to direct moisture away from the interior of the post, thereby preventing water intrusion and prolonging the lifespan of the post.

In yet another embodiment, the freestanding version of the device includes a lower portion having a weighted region comprising sand, metal, or composite material. The lower portion may further include a widened base and/or non-slip surface features to improve stability when the device is used independently of a post.

In certain embodiments, the internal engagement elements may comprise radially arranged ribs, protrusions, or compressible members that provide frictional retention within a post cavity. In other embodiments, the engagement elements may include tapered insertion members or inwardly biased skirt portions configured to provide a secure fit around an exterior surface of a post.

In additional embodiments, the removable insert or torch holder may be configured to receive a variety of lighting or decorative components, including oil torch canisters, candle holders, LED lighting modules, or other replaceable inserts, thereby expanding the functional utility of the device beyond traditional torch applications.

In one embodiment, the cap assembly includes a torch receptacle having a depth and diameter specifically configured to maintain a vertical alignment of a torch canister during exposure to lateral forces such as wind or incidental contact, wherein the receptacle includes at least one stabilizing surface configured to prevent rotational movement of the canister relative to the cap body.

In another embodiment, the cap body includes a multi-stage interior engagement system comprising a first set of engagement elements positioned at a first depth within the interior cavity and a second set of engagement elements positioned at a different depth, wherein the multiple sets of engagement elements enable engagement with posts of varying heights, wall thicknesses, and internal geometries.

In a further embodiment, the cap body comprises a layered construction including an outer structural layer and an inner heat-resistant layer, wherein the inner layer is positioned adjacent to the torch receptacle and is configured to withstand elevated temperatures without deformation, thereby increasing durability and safety during prolonged use.

In another embodiment, the cap body includes at least one mechanical retention feature configured to engage a corresponding feature on a torch canister or insert, wherein the mechanical retention feature comprises a detent, ridge, or locking interface that resists unintentional removal of the canister while still permitting intentional removal by a user.

In yet another embodiment, the cap assembly includes a venting system comprising one or more apertures positioned around the torch receptacle, wherein the apertures are configured to dissipate heat and combustion byproducts away from the cap body and post structure, thereby reducing heat accumulation and improving safety.

In one embodiment, the cap body is configured such that the torch receptacle is offset from a central axis of the post, thereby allowing the cap to accommodate internal obstructions within the post while still providing a stable mounting location for the torch canister.

In another embodiment, the cap assembly is configured to removably receive a plurality of interchangeable inserts, wherein each insert is configured for a different function selected from lighting, decoration, fluid containment, or sensor integration, thereby expanding the functional scope of the cap assembly beyond torch use.

In a further embodiment, the cap body includes a segmented or partially flexible skirt that can expand or contract to accommodate dimensional variations in posts caused by manufacturing tolerances, environmental expansion, or material inconsistencies.

In one embodiment, the invention is provided as a kit comprising a plurality of cap bodies, each configured to mount on a structural post, and a plurality of torch canisters configured to be removably received within the cap bodies, wherein the kit is packaged for installation across multiple posts within an outdoor environment.

In another embodiment, the kit further includes one or more adapter components configured to interface between the cap bodies and posts of varying sizes, wherein the adapter components enable installation on posts that do not conform to standard dimensions.

In a further embodiment, the kit includes at least one installation aid selected from alignment guides, measurement tools, or instructional materials configured to assist a user in properly installing the cap bodies on a plurality of posts.

In another embodiment, the kit comprises cap bodies formed from different materials or finishes, allowing a user to select a desired aesthetic or functional configuration, including plastic, metallic, or coated embodiments.

In yet another embodiment, the kit includes replacement components selected from additional torch canisters, wicks, snuffers, or heat shields, thereby enabling maintenance and extended use of the system over time.

In one embodiment, a method of installing a torch holding cap comprises positioning a cap body over a structural post and engaging at least one internal engagement element with the post to secure the cap body without the use of tools or fasteners.

In another embodiment, the method further comprises selecting an appropriate engagement mode from inserting the cap body into a hollow post or placing the cap body over an exterior surface of the post, based on the dimensions of the post.

In a further embodiment, the method includes inserting a torch canister into a receptacle formed in the cap body after the cap body has been secured to the post, thereby completing the installation.

In another embodiment, the method comprises positioning an adapter between the cap body and the post when the post dimensions fall outside a predefined range, thereby enabling proper alignment and secure attachment.

In yet another embodiment, the method includes placing the cap body on a horizontal surface in a freestanding configuration and inserting a torch canister into the receptacle, thereby enabling use of the device independent of a post.

In one embodiment, the cap assembly comprises a cap body having a top surface and a downwardly extending skirt, wherein the skirt includes at least one adjustable segment configured to move relative to the cap body to vary an effective internal dimension of the cap, thereby enabling the cap to securely engage posts of differing sizes.

In another embodiment, the cap assembly comprises a cap body including a receptacle configured to receive a removable insert, wherein the receptacle includes a keyed interface configured to align the insert in a predetermined orientation, thereby preventing improper installation and ensuring consistent positioning of a lighting element.

In a further embodiment, the cap assembly comprises a cap body including a central opening and a removable liner positioned within the opening, wherein the liner is formed of a heat-resistant material and is configured to receive a torch canister, thereby isolating heat from the surrounding cap body.

In another embodiment, the cap assembly comprises a cap body having an upper portion and a lower portion, wherein the upper portion is rotatably coupled to the lower portion and includes a receptacle for a lighting element, thereby allowing the receptacle to be oriented independently of the post.

In yet another embodiment, the cap assembly comprises a cap body including a magnetic or mechanical retention system configured to secure a removable insert within a receptacle, wherein the retention system resists displacement of the insert during environmental disturbances while permitting manual removal.

In one embodiment, the cap assembly comprises a cap body including an integrated fuel containment reservoir positioned within the cap body, wherein the reservoir is configured to supply fuel to a wick extending upward from the cap, thereby eliminating the need for a separate removable canister.

In another embodiment, the cap assembly comprises a cap body including an illumination module configured to produce light without combustion, wherein the illumination module is selected from an LED light source, battery-powered light, or solar-powered light, thereby enabling non-flame-based lighting alternatives.

In a further embodiment, the cap assembly comprises a cap body including a perimeter channel configured to receive a decorative or functional accessory ring, wherein the accessory ring may include lighting elements, ornamental features, or protective structures.

In another embodiment, the cap assembly comprises a cap body including a locking mechanism configured to secure the cap body to a post, wherein the locking mechanism includes at least one of a snap-fit feature, threaded interface, or mechanical fastener, thereby providing enhanced retention under high-load or high-wind conditions.

In yet another embodiment, the cap assembly comprises a cap body including at least one sensor integrated into the cap body, wherein the sensor is configured to detect environmental conditions selected from temperature, motion, or ambient light, and wherein the cap is configured to adjust operation of a lighting element in response to the detected condition.

In one embodiment, the cap assembly comprises a cap body including a fluid management system configured to collect, redirect, or drain liquids away from the receptacle and the underlying post, wherein the system includes one or more channels, openings, or sloped surfaces.

In another embodiment, the cap assembly comprises a cap body including a plurality of modular connection points configured to receive interchangeable components, wherein the interchangeable components are selected from lighting modules, planters, decorative elements, or utility fixtures.

In a further embodiment, the cap assembly comprises a cap body including an anti-tilt stabilization structure positioned within or beneath the cap body, wherein the stabilization structure is configured to maintain a vertical orientation of a lighting element during use.

In another embodiment, the cap assembly comprises a cap body including a collapsible or foldable portion configured to reduce the size of the cap for storage or transport, wherein the cap expands into a functional configuration during installation.

In yet another embodiment, the cap assembly comprises a cap body including a thermal expansion compensation structure configured to accommodate dimensional changes in the cap or post due to temperature variations, thereby maintaining secure engagement over a range of environmental conditions.

### BRIEF DESCRIPTION OF THE DRAWING FIGURES

Advantages of the present invention will be apparent from the following detailed description of embodiments, which description should be considered in conjunction with the accompanying drawings, in which:

FIG. 1 illustrates an isometric view of the Multi-Size Post Cap with Integrated Lighting Holder with a torch canister inserted for clarity of form, fit and function

FIG. 2 illustrates another isometric view of the Multi-Size Post Cap with Integrated Lighting Holder with a torch canister inserted for clarity of form, fit and function

FIG. 3 illustrates a bottom isometric view of the Multi-Size Post Cap with Integrated Lighting Holder with no inserted torch canister.

FIG. 4 illustrates an isometric view of the Multi-Size Post Cap with Integrated Lighting Holder with a lit torch canister, wherein the cap is shown secured on a 4 foot fence or deck post with an adapter.

FIG. 5 illustrates a top view of the Multi-Size Post Cap with Integrated Lighting Holder with a lit torch canister.

FIG. 6 illustrates an isometric view of the Multi-Size Post Cap with Integrated Lighting Holder with a lit torch canister, wherein the cap is shown secured on a 5 foot fence with no adaptor.

FIG. 7 illustrates an isometric view of the Multi-Size Post Cap with Integrated Lighting Holder with no inserted torch canister.

FIG. 8 illustrates another bottom isometric view of the Multi-Size Post Cap with Integrated Lighting Holder with no inserted torch canister.

FIG. 9 illustrates another isometric view of the Multi-Size Post Cap with Integrated Lighting Holder with no inserted torch canister.

### DETAILED DESCRIPTION

In describing the preferred and alternate embodiments of the present invention, specific terminology is employed for the sake of clarity. The invention, however, is not intended to be limited to the specific terminology so selected.

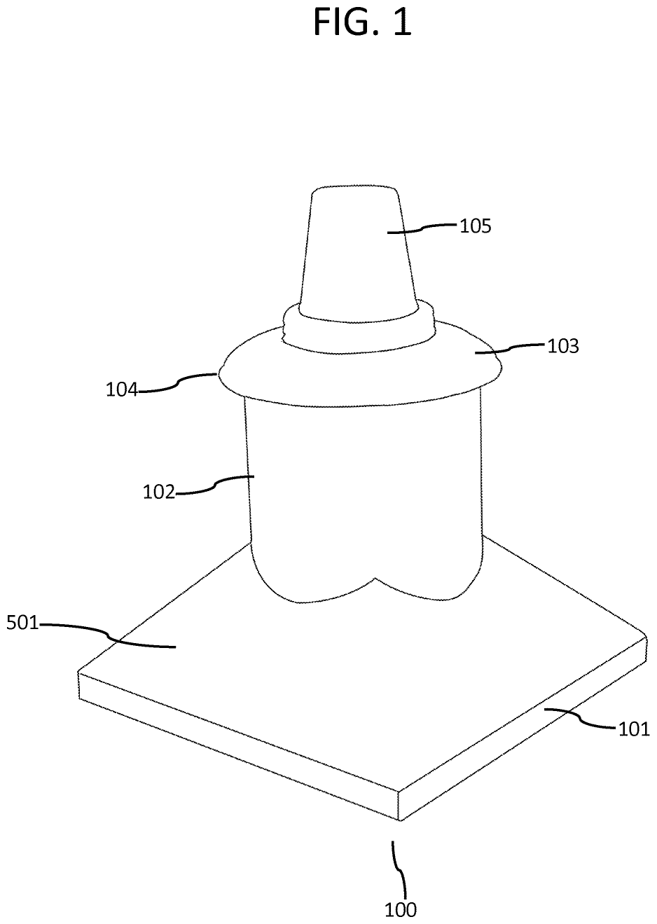

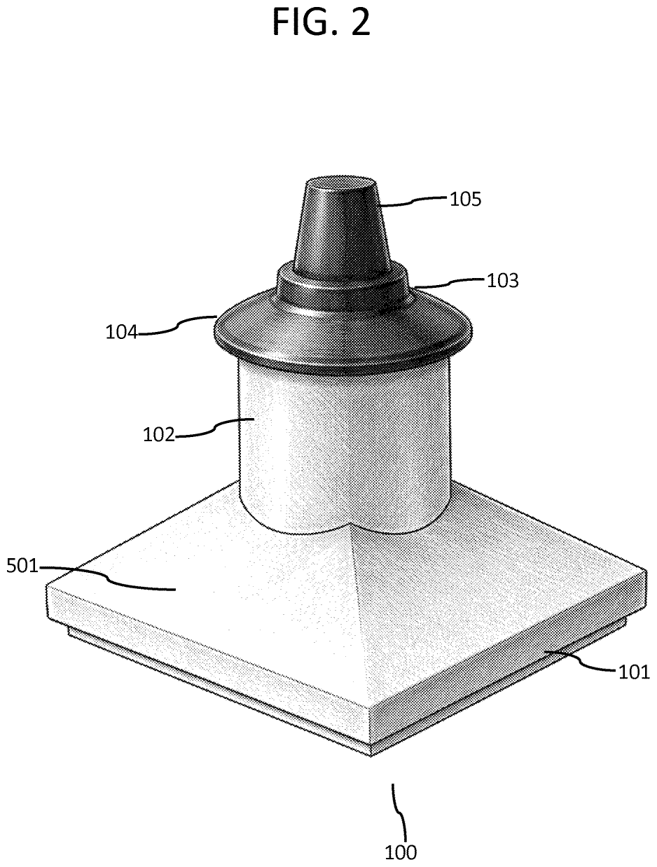

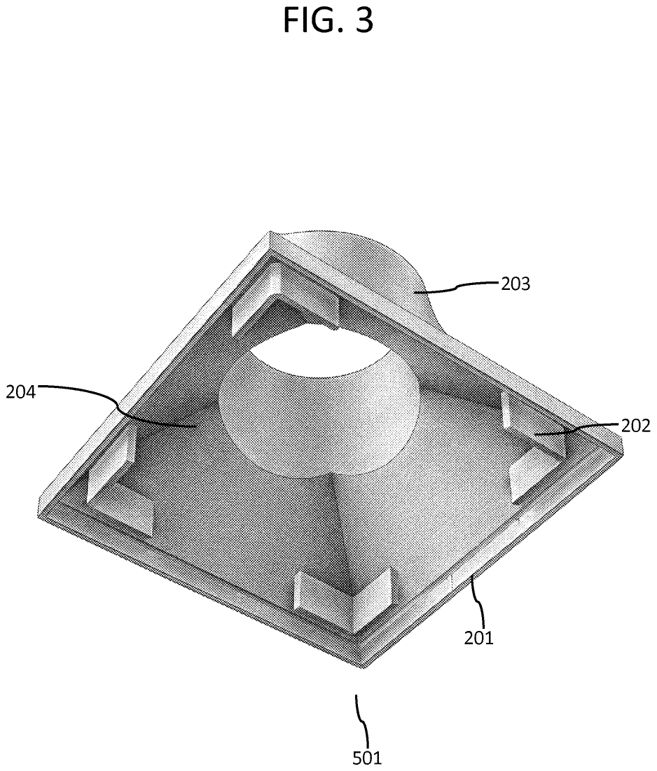

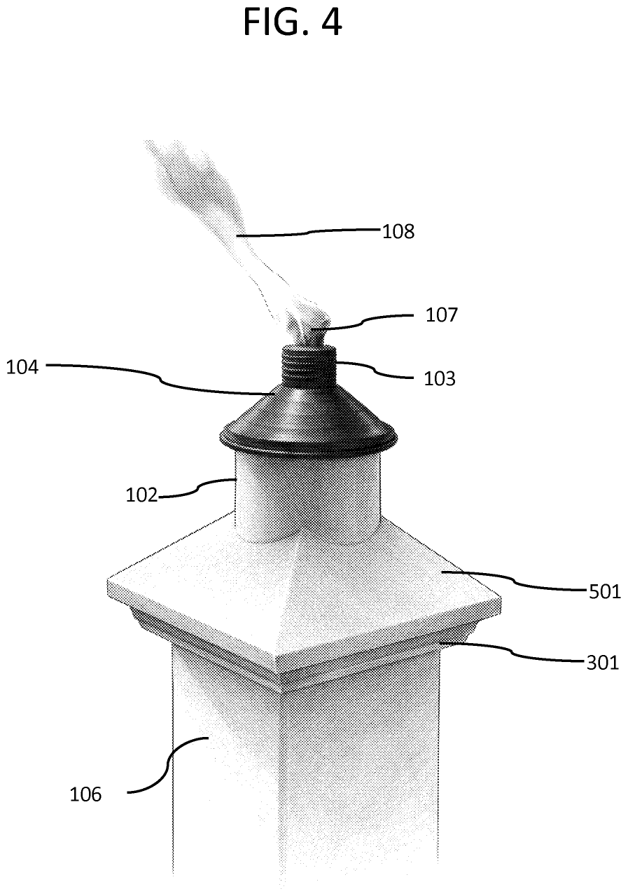

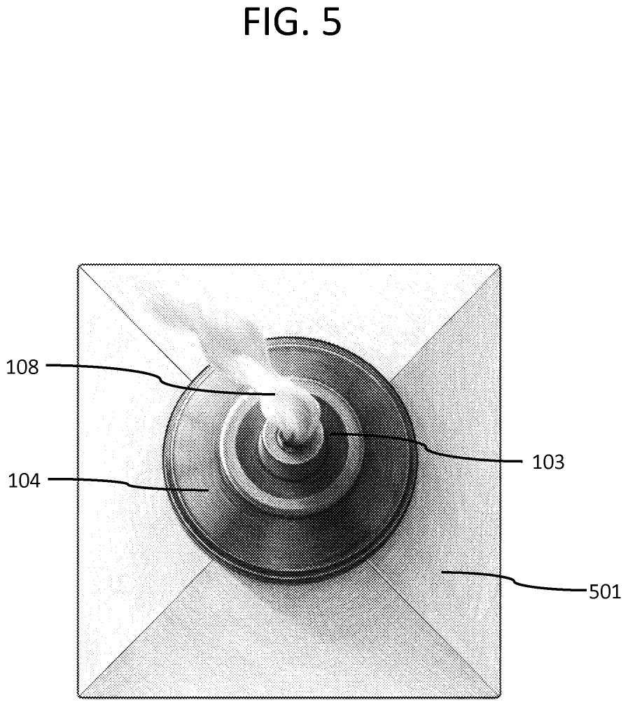

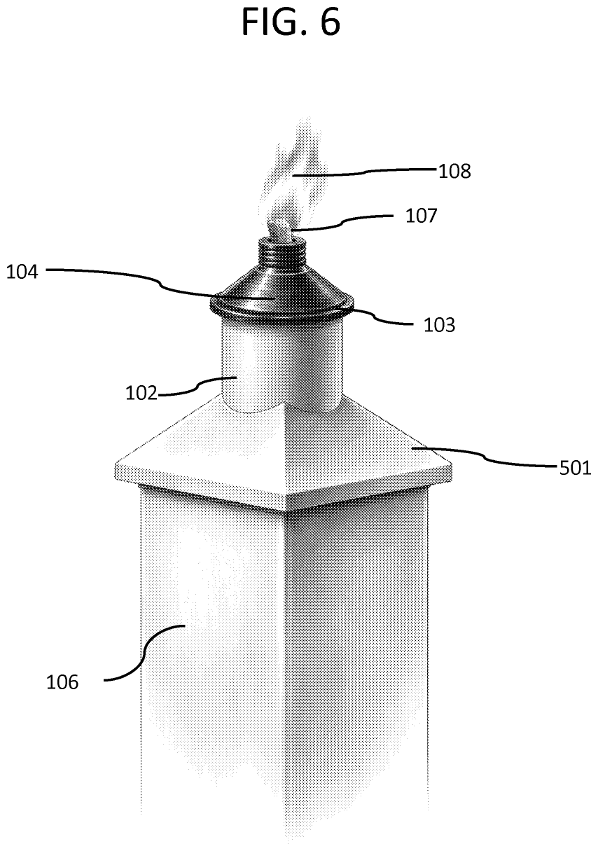

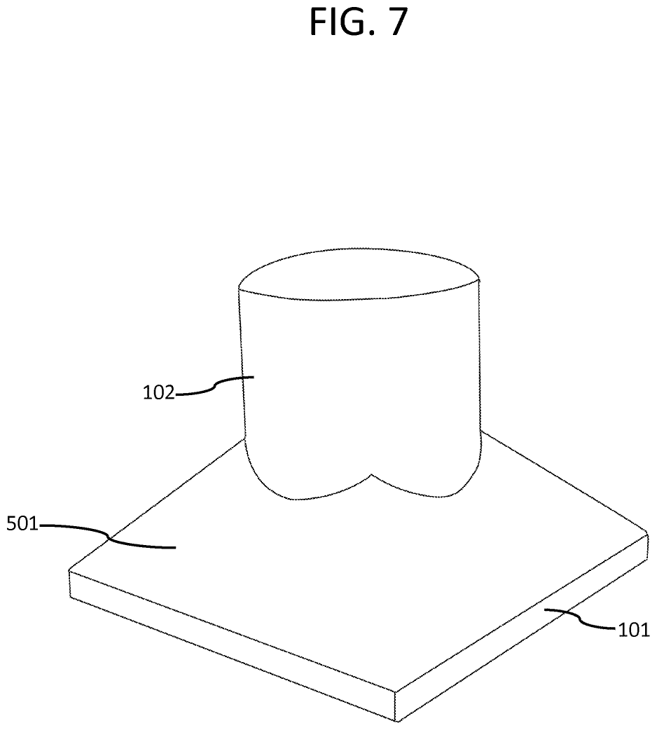

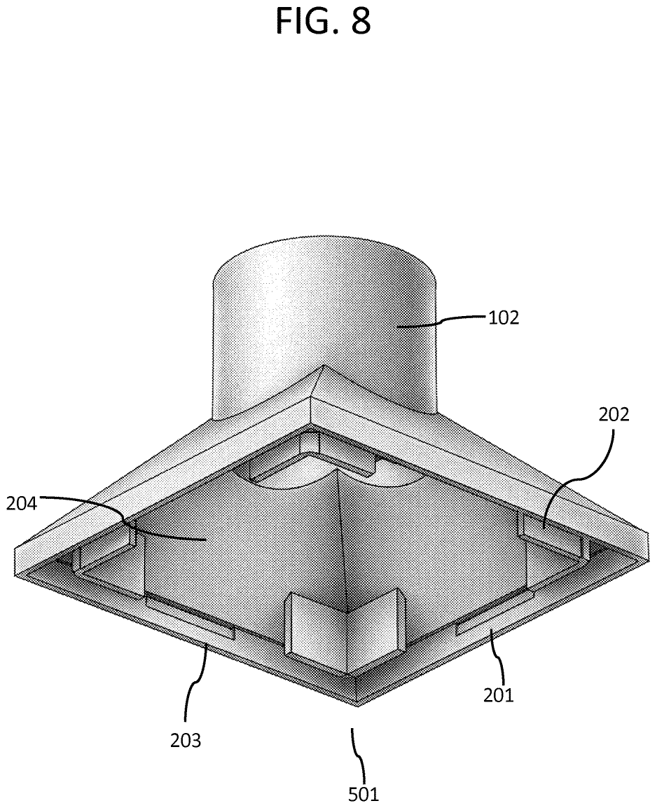

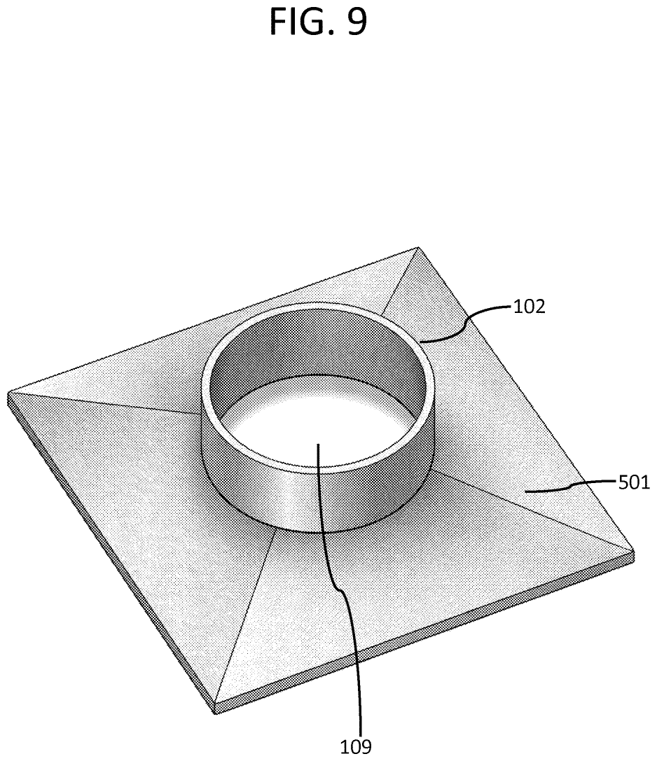

Referring now in detail to the drawing figures, wherein like reference numerals designate like elements throughout the several views, FIGS. 1-9 illustrate a multi-size post cap with integrated lighting holder 100 in accordance with a preferred embodiment of the present invention.

In the preferred embodiment, the multi-size post cap 100 includes a modular base cap 501 configured to receive and support an oil torch canister 103, a heat shield 104, and a wick snuffer 105. The base cap 501 is further configured to securely attach to an existing fence or deck post 106.

The base cap 501 includes a peripheral wall 203 defining an interior cavity 204. The interior cavity 204 is dimensioned to receive the oil torch canister 103 such that the canister is positioned within the base cap 501 without interference from the fence or deck post 106 when installed. The peripheral wall 203 includes a top exterior surface having sufficient thickness to provide structural strength and durability while maintaining a lightweight and slightly flexible construction. Although the wall thickness may vary, a preferred thickness is approximately 0.2 mm to 0.3 mm.

A circular protrusion 102 extends upwardly from the base cap 501 and defines a top opening 109. The top opening 109 is configured to permit a wick 107 of the oil torch canister 103 to extend above the base cap 501. When positioned through the opening 109, the wick 107 may be ignited to produce a flame 108.

The interior of the base cap 501 is configured to accommodate fence or deck posts of varying sizes. In particular, the base cap 501 includes a plurality of corner retention brackets 202 positioned along interior surfaces, the brackets being configured to engage, align with, or frictionally interface with corresponding interior or exterior surfaces of the fence post 106 or post cavity.

A small channel insert 201 is provided and is configured to interface the base cap 501 with standard four-inch PVC fence caps or adapters, thereby enabling the base cap 501 to securely fit smaller post dimensions.

Additionally, the base cap 501 includes an outer lip 101 extending around a lower perimeter thereof. The lip 101 is configured to overlap an exterior portion of the fence post 106 or an associated post adapter, thereby assisting in stabilizing the base cap 501 and reducing water ingress into the interior of the post cavity.

In use, the base cap 501 may be installed onto a fence post 106 either by inserting the post into the interior cavity 204 such that the retention brackets 202 engage the post, or by positioning the outer lip 101 over the exterior of the post or post adapter to achieve a secure and stable fit.

In various alternative embodiments, the base cap 501 and associated components may be formed from a wide range of materials selected based on durability, cost, environmental exposure, and aesthetic considerations. Suitable materials include, but are not limited to, polyvinyl chloride (PVC), chlorinated PVC (CPVC), polyethylene (PE), high-density polyethylene (HDPE), polypropylene (PP), acrylonitrile butadiene styrene (ABS), polycarbonate, nylon, composite polymers, thermoplastic elastomers (TPE), thermoset plastics, rubber, silicone, glass, ceramic, aluminum, stainless steel, galvanized steel, powder-coated metals, or combinations thereof. In some embodiments, the base cap 501 may include layered or multi-material construction, such as a rigid structural core combined with a flexible outer interface to improve fit and weather resistance.

In further embodiments, the base cap 501 may be configured for installation on a variety of post types and geometries. These include, without limitation, square, rectangular, circular, oval, hexagonal, or irregularly shaped fence or deck posts. The posts may be formed from wood, vinyl, PVC, composite materials, metal, aluminum, steel, fiberglass, or masonry structures. The base cap 501 may be dimensioned or adapted to fit standard post sizes, including but not limited to nominal sizes such as 4×4, 5×5, 6×6 posts, metric equivalents, or non-standard custom dimensions. In certain embodiments, the base cap 501 may be used with hollow posts, solid posts, sleeved posts, or posts having internal cavities or reinforcement structures.

In some embodiments, the base cap 501 may be configured to engage posts using different attachment mechanisms. These may include friction fit engagement, snap-fit engagement, press-fit engagement, threaded engagement, adhesive bonding, mechanical fasteners, clips, set screws, detents, locking tabs, or combinations thereof. In other embodiments, the cap may include adjustable or flexible internal structures configured to accommodate dimensional variations between posts, including expandable ribs, compressible inserts, spring-biased elements, or deformable retention members.

In additional embodiments, the lighting element supported by the base cap 501 may include a variety of fuel-based canisters. These include, but are not limited to, oil torch canisters, citronella fuel canisters, paraffin-based fuel containers, biofuel containers, ethanol-based fuel reservoirs, kerosene-based systems, gel fuel containers, refillable fuel cartridges, and disposable fuel canisters. The canisters may vary in size, shape, threading configuration, refill mechanism, and burn duration, and may be removably or permanently secured within the base cap 501.

In further embodiments, the lighting element may comprise non-fuel-based illumination sources. These may include, without limitation, LED lighting modules, solar-powered lighting assemblies, battery-powered lights, rechargeable lighting units, filament-style electric lights, low-voltage landscape lighting fixtures, or smart lighting systems capable of remote or automated control. In such embodiments, the circular protrusion 102 and top opening 109 may be adapted to support electrical components, wiring pathways, battery housings, or solar panels.

In still further embodiments, the upper receiving structure of the base cap 501 may be configured to accommodate non-lighting functional or decorative elements. These may include planters, decorative finials, flags, sensors, cameras, speakers, insect-repelling devices, fragrance diffusers, or seasonal decorative attachments. Accordingly, the structure described herein may function as a universal mounting platform for a variety of interchangeable modules.

In some embodiments, the base cap 501 may include additional environmental or functional features. These may include drainage channels, weep holes, sealing gaskets, weather-resistant coatings, UV-resistant materials, flame-resistant materials, heat-dissipating structures, or insulating layers to protect the underlying post from heat exposure. In certain configurations, the heat shield 104 may be integrated into the base cap 501 or formed as a separate removable or replaceable component.

In alternative embodiments, the internal structures, including the corner retention brackets 202, may take on different geometries or configurations. These may include ribs, fins, protrusions, spring clips, compressible pads, continuous ledges, segmented supports, or adjustable members. The structures may be positioned at corners, along sidewalls, or distributed throughout the interior cavity 204, and may function to align, stabilize, or retain the base cap 501 relative to the post.

In some embodiments, the base cap 501 may be configured as part of a modular system including interchangeable components. Such components may include different sizes of inserts, adapters, or sleeves to accommodate varying post dimensions, as well as interchangeable upper assemblies for different lighting or decorative applications. The system may be sold as a kit or assembled in the field based on user preference.

In yet further embodiments, the base cap 501 may be configured for use in environments beyond fencing or decking. These may include docks, railings, pergolas, gazebos, outdoor structures, signage posts, landscape features, or indoor applications where a post-mounted lighting or decorative feature is desired.

In some embodiments, the base cap 501 may also be configured for standalone use independent of a post. In such configurations, the base cap may include a weighted base, a flat mounting surface, or stabilizing features allowing placement on horizontal surfaces such as tables, patios, or ground surfaces, thereby functioning as a tabletop or freestanding lighting device.

In certain embodiments, any structural element described herein as having a particular shape, orientation, or configuration (including, for example, cylindrical, square, L-shaped, angled, or planar features) may instead be implemented using functionally equivalent geometries that achieve substantially the same result. Thus, features described as tabs, brackets, ribs, walls, protrusions, lips, or inserts may be substituted with continuous or discontinuous structures, curved or faceted geometries, flexible or rigid members, or integrated or multi-part constructions. Unless expressly limited, no specific geometry, angle, or relative positioning of such elements is required, and all such variations that perform a retaining, aligning, supporting, spacing, sealing, or interfacing function are contemplated within the scope of the invention.

In further embodiments, components described as separate elements may be integrally formed, while components described as integral may instead be formed as multiple discrete parts joined by any suitable method. For example, the base cap 501, protrusion 102, retention structures 202, lip 101, and any inserts or adapters may be manufactured as a single monolithic component, or as a multi-part assembly joined by molding, bonding, welding, mechanical fastening, snap-fit engagement, or other joining techniques. Similarly, any interface between components may be permanent, removable, adjustable, or modular. This interchangeability of construction is intended to encompass both unitary and assembled configurations without limitation.

In some embodiments, any feature described as interacting with, engaging, supporting, or receiving another component (such as a post, canister, insert, or lighting element) may do so directly or indirectly through one or more intermediate structures. Such intermediate structures may include adapters, sleeves, spacers, bushings, gaskets, collars, or other interface elements, whether separately provided or integrated into the base cap 501 or associated components. Accordingly, references to a component engaging or being mounted to another component should be understood to include both direct engagement and indirect engagement through one or more intervening elements, thereby broadening the scope of coverage to include systems in which equivalent functionality is achieved through intermediary structures.

In certain embodiments, features described herein as being positioned within, on, or as part of the base cap 501 may alternatively be located partially or entirely outside of the base cap 501 while still performing substantially the same function. For example, retention structures, support members, alignment features, sealing elements, lighting supports, or canister-receiving structures may be positioned externally on the base cap 501, on the post 106, or on an intermediate adapter or accessory component, provided that such structures cooperate with the base cap 501 to achieve the intended mounting, stabilization, or functional relationship.

Accordingly, any reference to a component being “within,” “inside,” “integrated into,” or “formed as part of” the base cap 501 should be understood to also encompass configurations in which such components are positioned externally, adjacent to, or spaced apart from the base cap 501, so long as they functionally interact with the base cap 501 to produce the same or substantially similar result. This includes embodiments in which the primary structural or functional features are distributed across multiple components rather than being concentrated within a single cap structure.

In additional embodiments, one or more surfaces of the cap body may include coatings, treatments, or finishes configured to enhance durability, safety, or aesthetic appearance. Such coatings may include UV-resistant coatings, fire-retardant coatings, corrosion-resistant coatings, hydrophobic or waterproof layers, anti-slip textures, powder coatings, anodized finishes, painted finishes, or protective sealants. These treatments may be applied to internal or external surfaces and may be uniform or selectively applied.

In further embodiments, the cap assembly may include safety features configured to manage or mitigate risks associated with open flame or heat generation. Such features may include flame guards, wind shields, spark arrestors, flame diffusers, automatic extinguishing mechanisms, tip-over shutoff systems, thermal cutoffs, or flame height regulators. These features may be integrated into the cap body or provided as removable or modular components.

It will be understood that the embodiments described herein are illustrative and not limiting, and that various modifications, substitutions, and alterations may be made without departing from the spirit and scope of the invention. Unless expressly stated otherwise, terms such as “including,” “comprising,” and “having” are intended to be open-ended and inclusive rather than exclusive. Any feature described in connection with a particular embodiment may be combined with features of other embodiments, whether or not expressly described. Additionally, all structural and functional elements disclosed herein are intended to encompass not only the specific embodiments shown and described, but also all equivalents thereof, whether currently known or later developed, including technologies, materials, manufacturing methods, or configurations that perform substantially the same function, in substantially the same way, to achieve substantially the same result. Accordingly, the invention is intended to cover all such modifications, variations, and equivalents that fall within the scope of the appended claims, including those that may arise from advances in technology or design after the filing date of this application.

While several variations of the present invention have been illustrated by way of example in particular embodiments, it is apparent that further embodiments could be developed within the spirit and scope of the present invention. However, it is to be expressly understood that such modifications and adaptations are within the spirit and scope of the present invention, and are inclusive, but not limited to the following appended claims as set forth.

1. A post-mounted support assembly for supporting a lighting or decorative element, comprising:
a cap body including a top surface and a downwardly extending skirt defining an interior cavity;
the interior cavity being configured to engage a structural post;
a receptacle formed in or coupled to the cap body, the receptacle being configured to receive and stabilize a removable insert comprising a lighting or decorative element; and
at least one internal engagement element disposed within the interior cavity and configured to engage at least one of an interior surface or an exterior surface of the structural post to secure the cap body relative to the structural post without requiring external fasteners.

2. A modular support system for mounting a lighting or decorative element, comprising:
a base cap configured to be mounted to a structural post, the base cap including an interior engagement region configured to engage the structural post;
a removable insert configured to be received within a receptacle of the base cap; and
wherein the removable insert comprises a lighting or decorative element and is selectively removable and replaceable relative to the base cap,
wherein the base cap is configured to accommodate structural posts of differing sizes or shapes through at least one of a plurality of engagement features, deformable structures, or adapter components.

3. The assembly of claim 1, wherein the receptacle is configured to receive an oil torch canister including a fuel reservoir and a wick.

4. The assembly of claim 1, wherein the receptacle is configured to receive a non-combustion lighting element selected from an LED module, solar-powered light, or battery-powered light.

5. The assembly of claim 1, wherein the cap body is formed from a material selected from PVC, CPVC, polyethylene, polypropylene, ABS, polycarbonate, metal, rubber, silicone, glass, ceramic, or combinations thereof.

6. The assembly of claim 1, wherein the cap body comprises a multi-material construction including a structural portion and a heat-resistant portion.

7. The assembly of claim 1, wherein the interior cavity includes a plurality of engagement elements arranged to accommodate posts of differing cross-sectional shapes.

8. The assembly of claim 7, wherein the differing cross-sectional shapes include square, rectangular, circular, or irregular shapes.

9. The assembly of claim 1, wherein the at least one internal engagement element comprises at least one of a rib, protrusion, bracket, compressible member, or spring-biased element.

10. The assembly of claim 1, wherein the cap body is configured to engage the structural post through at least one of a friction fit, press fit, snap-fit, threaded engagement, adhesive, or mechanical fastener.

11. The assembly of claim 1, wherein the receptacle includes at least one stabilizing surface configured to reduce rotational movement of the removable insert.

12. The assembly of claim 1, further comprising a heat management structure configured to reduce heat transfer from the lighting element to the cap body or structural post.

13. The assembly of claim 12, wherein the heat management structure includes at least one of a heat shield, air gap, or insulating layer.

14. The assembly of claim 1, wherein the cap body further includes a lip configured to overlap an exterior portion of the structural post.

15. The assembly of claim 1, wherein the cap body includes at least one drainage channel configured to direct moisture away from the interior cavity.

16. The assembly of claim 1, wherein the receptacle is non-circular and is shaped to correspond to a geometry of the removable insert.

17. The assembly of claim 1, wherein the receptacle is oriented at an angle relative to the structural post.

18. The system of claim 2, wherein the removable insert is secured within the base cap by at least one of a snap-fit, threaded interface, magnetic retention, or detent mechanism.

19. The system of claim 2, further comprising at least one adapter configured to interface the base cap with a structural post having a non-standard size.

20. The system of claim 2, wherein the base cap includes a deformable engagement structure configured to elastically adjust to variations in post dimensions.
